(19) United States
(12) Patent Application Publication
(10) Pub. No.: US 2019/0006696 A1
(43) Pub. Date: Jan. 3, 2019

(54) FUEL CELL

(71) Applicant: Panasonic Intellectual Property Management Co., Ltd., Osaka (JP)

(72) Inventors: MIYUKI YOSHIMOTO, Osaka (JP); YOSHIFUMI TAGUCHI, Osaka (JP); TSUTOMU KAWASHIMA, Nara (JP); HIROAKI SUZUKI, Osaka (JP)

(21) Appl. No.: 16/016,623

(22) Filed: Jun. 24, 2018

(30) Foreign Application Priority Data
Jul. 3, 2017 (JP) 2017-130045
Apr. 4, 2018 (JP) 2018-072484

(51) Int. Cl. H01M 8/242; H01M 8/1004; H01M 8/0273; H01M 8/0267; H01M 8/0258; H01M 4/88

(52) U.S. Cl. CPC H01M 8/242; H01M 8/1004; H01M 8/0273; H01M 2008/1095; H01M 8/0258; H01M 4/8807; H01M 8/0267

(57) ABSTRACT

A fuel cell, including: a polymer electrolyte membrane; a pair of catalyst layers; a pair of gas-diffusion layers; a pair of separators including first and second separators; and at least one frame, wherein the catalyst layers, the gas-diffusion layers, and the separators are placed respectively on both sides of the polymer electrolyte membrane in this order, the at least one frame is placed between the pair of the separators, and surrounds outer peripheries of the gas-diffusion layers and the catalyst layers, and the frame has a rigidity of about 1 GPa or higher in terms of the Young's modulus.

### TECHNICAL FIELD

The technical field relates to fuel cell gaskets, fuel cells, and methods for producing the fuel cells.

### BACKGROUND

Fuel cells such as polymer electrolyte fuel cells have stack structures in which single cells including membrane-electrode assemblies (MEAs) and pairs of separators are stacked, and certain fastening loads are applied to the single cells in the stack direction.

In each of the single cells, an in-plane center of the cell is a power generation area in which a fuel gas, and an air gas are supplied to cause power generation, and an area around the power-generation area is a non-power-generation area that seals the fuel gas, the air gas, and a refrigerant water.

In the non-power-generation area of each of the cells, outer edges of electrolyte membranes are supported by a frame made of an insulative material. Frames are attached to one another by use of an elastic adhesive, so as to form into a single body, such that the single cell exhibits a certain value of internal resistance.

The above-described structure tolerably receives a fastening load applied to the elastic adhesive-coated parts and absorbs dimension tolerances of the components in each stack direction. Thus, bringing about effects to suppress variations in plane pressures applied to the power-generation area and the non-power-generation area, even if variations in dimensions are caused during the assembly process (JP-A-7-249417).

### SUMMARY

However, components of single cells (frame, seals, separators, MEAs, gas-diffusion layers) will have dimensional variations that are caused during the production processes.

Consequently, when certain fastening loads are applied to the components during the stacking processes, distributions of in-plane loads will be caused due to dimensional variations of components caused during the assembly processes.

In order to suppress the contact resistance to low levels and thereby maintain sufficient performance of fuel cells, it would be required that large amounts of fastening loads are applied thereto, such that required contact plane pressures are applied to the entire region of the power-generation areas, even when in-plane variations in the fastening loads are caused. However, there are concerns that the separators and the frames would deform.

When the separators and the frames deform, spaces inside the cells change during the fastening processes, and thus, loss of pressure in gas-supplying parts and power-generation flow channels would vary in each of the cells.

If that happens, supplies of gases to the cells will vary during the stacking processes, and thus, outputs in the cells will differ from each other. This leads to deteriorated performance of fuel cells.

Furthermore, to realize a reduced stack thickness of a single cell, it is required that a thickness of a frame is reduced. However, if reduction of thickness of a frame is attempted, a thickness of frame that has strength to stand against a required load would not be realized, and reliability of the cell structure may be impaired.

An object of the disclosure is to make it possible to suppress occurrence of distortions of separators in fuel cells, and further make it possible to reduce the stack thickness of the single cell.

In order to achieve the above-mentioned object, provided is a fuel cell, including: a polymer electrolyte membrane; a pair of catalyst layers; a pair of gas-diffusion layers; a pair of separators including first and second separators; and at least one frame, wherein the catalyst layers, the gas-diffusion layers, and the separators are placed respectively on both sides of the polymer electrolyte membrane in this order, the at least one frame is placed between the pair of the separators, and surrounds outer peripheries of the gas-diffusion layers and the catalyst layers, and the frame has a rigidity of about 1 GPa or higher in terms of the Young's modulus.

According to the disclosure, it becomes possible to prevent occurrence of distortions of frames in stack structures in singles cells of fuel cells. Structures tolerant to fastening loads can be realized even in cases where the thickness of frame is reduced. Accordingly, it becomes easier to realize a thinner structure that achieves reduced thickness of single cell and reduced thickness of the stack.

### BRIEF DESCRIPTION OF THE DRAWINGS

FIG. 1 is an exploded perspective view that shows a stack structure found in a fuel cell including single cells.

FIG. 2A is a cross-section view of a single cell in a fuel cell according to a first embodiment along the lines D-D in FIG. 1.

FIG. 2B is a cross-section view of a single cell in a fuel cell according to a third embodiment along the lines D-D in FIG. 1.

FIG. 3A is a plan view of a separator (at the air electrode side) in the first embodiment.

FIG. 3B is a plan view of a separator (at the air electrode side) in the first embodiment.

FIG. 4A is a plan view of a separator (at the fuel side) in the first embodiment.

FIG. 4B is a plan view of a separator (at the fuel side) in the first embodiment.

FIG. 5A is a plan view of a frame in the first embodiment.

FIG. 5B is a plan view of a frame in the first embodiment.

FIG. 6 is a cross-section view of an area along the line B-B in FIG. 3B in the second embodiment.

FIG. 7 is a cross-section view of an area along the line C-C in FIG. 3B in the second embodiment.

FIG. 8A is a perspective view that shows a frame and islands in the second embodiment.

FIG. 8B is a perspective view that shows a frame and islands in the second embodiment.

FIG. 9A is a cross-section view of an area along the line A-A in FIG. 2B in the fourth embodiment.

FIG. 9B is a cross-section view of an area along the line A-A in FIG. 2B in the fourth embodiment.

FIG. 10 is a cross-section view of an area along the line A-A in FIG. 2B in the fifth embodiment.

FIG. 11 is a cross-section view of an area along the line B-B in FIG. 3B in the sixth embodiment.

FIG. 12 is a plan view that shows a first-gas-introducing part in a separator (at the air electrode side) in an example.

FIG. 13 is a plan view of a measurement specimen that is subjected to the test based on JIS K 7161 (Plastics-Determination of tensile properties).

FIG. 14 is a diagram that shows stress-strain results with respect to a frame specimen in the example.

### DESCRIPTION OF EMBODIMENTS

Hereinafter, embodiments of the disclosure will be described with reference to the drawings.

The same components will be referenced by the same symbols in the drawings, and repetitions in overlapping descriptions therefor may be omitted.

Additionally, the embodiments are merely examples, and therefore, do not restrict the scope of the disclosure. Any features and combinations thereof described in the embodiments are not necessarily essential parts of the disclosure.

### First Embodiment

### <Fuel Cell Stack 100>

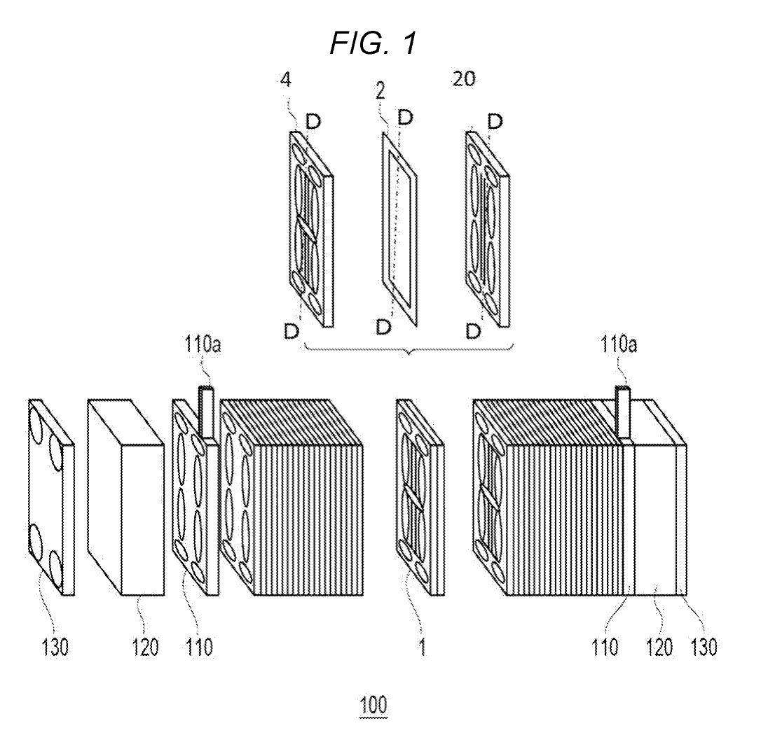

As shown in FIG. 1, a fuel cell stack 100 have a structure in which multiple cells 1 according to this embodiment are stacked.

Gaskets (not shown in figures) are provided between adjacent cells 1.

At both sides of the cells 1 in the stack direction, current collector plates 110, insulation plates 120, and fastening plates 130 are placed in this order.

Then, by applying certain loads to the fastening plates 130 from the both sides in the stack direction, multiple stacked cells 1 are fastened so as to form the fuel cell stack 100.

A current collection terminal 110a is provided in each of the current collector plates 110.

Currents are collected from the terminals 110a during power generation in the cells 1.

The insulation plates 120 each secure isolation between the current collector plates 110 and the fastening plates 130.

The insulation plates 120 may be provided with inlets and outlets for gases or refrigerant water (not shown in figures).

When certain loads are applied to the fastening plates 130 from the outside, the pair of fastening plates 130 fastens the multiple stacked cell 1, the pair of current collector plates 110, and the pair of insulation plates 120.

Each of the cells 1 has a structure in which a multiple-layer member 2 is placed between a pair of first separators 4 and 20.

### <Structure of Cell 1>

Hereinafter, a structure of each cell 1 will be described.

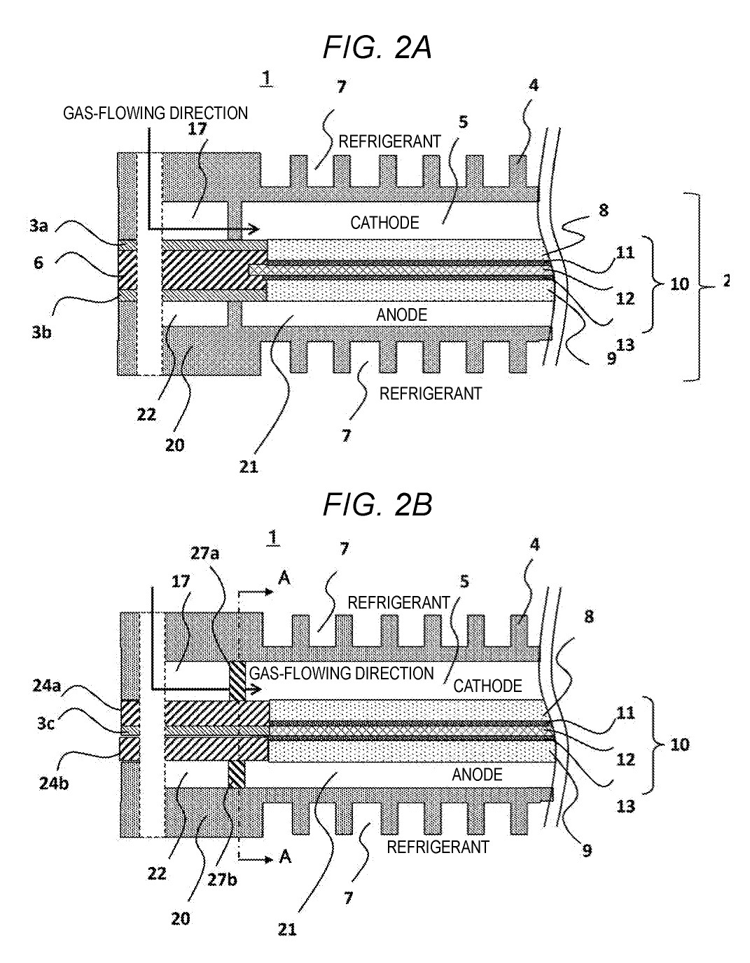

FIG. 2A is a partially-enlarged cross-section view of an area of the cell 1 along the lines D-D in FIG. 1.

As shown in FIG. 2A, the cell 1 is provided with the multiple-layer member 2, the pair of first separators 4 and 20, and the frame 6.

The multiple-layer member 2 is formed by a membrane-electrode assembly 10, a cathode-gas-diffusion layer 8, and an anode-gas-diffusion layer 9.

The membrane-electrode assembly 10 has an approximately tabular shape.

The cathode-gas-diffusion layer 8 and the anode-gas-diffusion layer 9 are provided in such a manner that the membrane-electrode assembly 10 is placed therebetween, and main surfaces of the cathode-gas-diffusion layer 8 and the anode-gas-diffusion layer 9 face one another.

The first separators 4 is stacked on a main surface of the cathode-gas-diffusion layer 8 on the side opposite to the membrane-electrode assembly 10, and the second separators 20 is stacked on a main surface of the anode-gas-diffusion layer 9 on the side opposite to the membrane-electrode assembly 10.

The membrane-electrode assembly 10 includes an electrolyte membrane 12, a cathode catalyst layer 11 placed on one main surface of the electrolyte membrane 12, and an anode catalyst layer 13 placed on the other main surface of the electrolyte membrane 12.

The electrolyte membrane 12 exhibits sufficient ion conductivity in wet states and serves as an ion-exchange membrane that causes protons to move between the cathode catalyst layer 11 and the anode catalyst layer 13.

For example, the electrolyte membrane 12 may be made of a fluorine resin.

The cathode catalyst layer 11, and the anode catalyst layer 13 each contain ion-exchange resins and catalyst particles, and carbon particles carrying catalyst particles, as needed.

The ion-exchange resins can be formed of polymer materials in the same manner the electrolyte membrane 12.

The catalyst particles may be made of Pt, alloys of Pt and other metals, or the like.

The carbon particles may be made of acetylene black, Ketjen black, or the like.

The electrolyte membrane 12 may have a surface area that is equal to or larger than the surface area of the cathode catalyst layer 11 or the anode catalyst layer 13.

The cathode-gas-diffusion layer 8 is stacked on an outer main surface of the cathode catalyst layer 11, and the anode-gas-diffusion layer 9 is stacked on an outer main surface of the anode catalyst layer 13.

The cathode-gas-diffusion layer 8, and the anode-gas-diffusion layer 9 may be made of carbon papers or the like.

A resin-made frame 6 is provided around the outer periphery of the membrane-electrode assembly 10.

The frame 6 may be formed of a resin material having a degree of rigidness exhibiting a Young's modulus of 1 GPa or higher.

Thus, the frame 6 can absorb thermal expansion caused in the stack direction of the cell 1.

The frame 6 may be made of a thermoset epoxy material including glass fibers.

As a result, distortions of the frame can be suppressed in the stack structure of single cells in the fuel cell.

The resulting fuel cell can have structures in which the thickness of each single cell, and the thickness of the stack are smaller.

### <First Separators 4 and 20>

The first separators 4, 20 may be formed of, e.g., carbon plates, or metal plates made of titanium, stainless steel, aluminum, or the like.

The first separators 4 and 20 may have cross-sectional shapes of recesses and projections formed based on, e.g., metal press working or etching working.

The first separators 4 are provided with a cathode gas flow channel 5 for supplying a cathode gas, and the second separators 20 are provided with an anode gas flow channel 21.

Refrigerant flow channels 7 are formed on back sides of the cathode gas flow channel 5 and the anode gas flow channel 21 of the first separators 4 and 20, respectively.

### <First Separator 4>

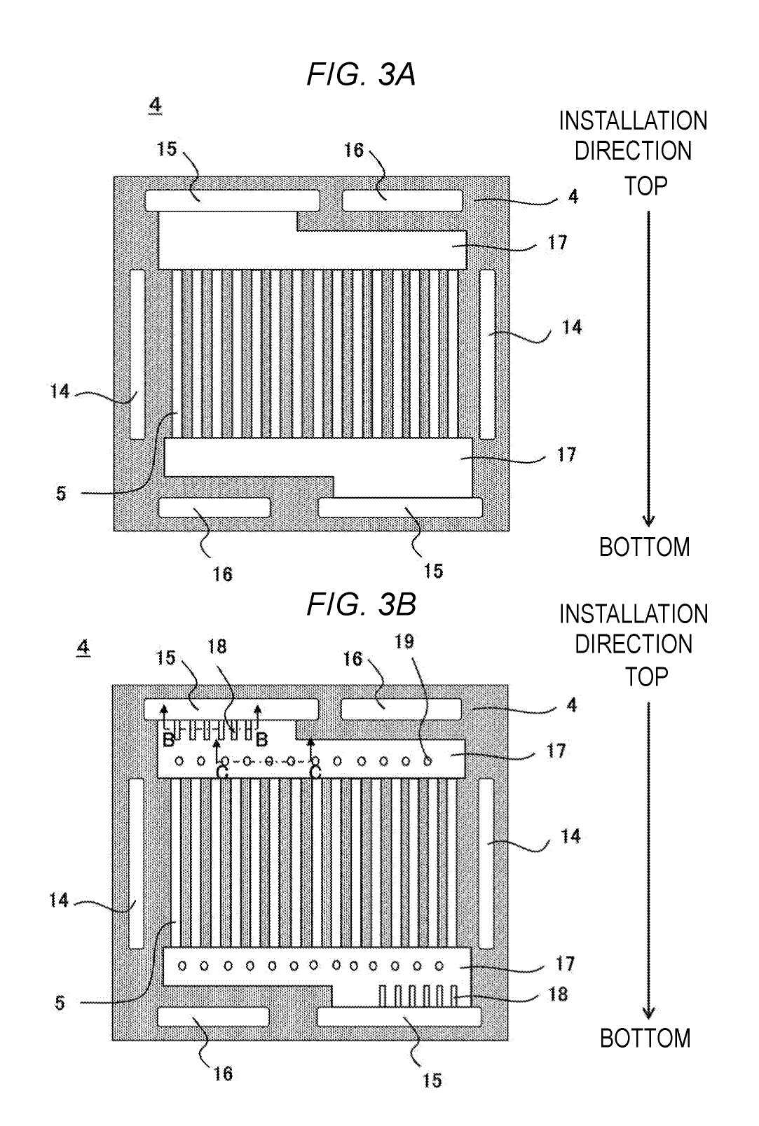

FIG. 3A is a plan view of the first separator 4 at the cathode side.

In the first separators 4, refrigerant manifold pores 14, first manifold pores 15, and second manifold pores 16 are formed.

The refrigerant manifold pore 14 communicates with the refrigerant flow channel 7 (FIG. 2A). Thus, the refrigerant manifold pore 14 supplies a refrigerant through a supply pipe, and then, drains the refrigerant.

The first manifold pore 15 communicates with the cathode gas flow channel 5. Thus, the first manifold pore 15 supplies an oxidant gas including the air, from a supply pipe, and then, drains the oxidant gas.

The second manifold pore 16 communicates with the anode gas flow channel 21. Thus, the second manifold pore 16 supplies a fuel gas including a hydrogen gas, through a supply pipe, and then, drains the fuel gas.

As shown in FIG. 3A, the first separators 4 at the cathode side are provided with the first manifold pore 15, and a first gas-introducing part 17 that communicates with cathode gas flow channels 5.

As shown in FIG. 3B, the first gas-introducing part 17 may be provided with multiple linear projections 18 that communicate with one end of the first manifold pore 15, and islands 19 formed as column-shaped projections.

The linear projections 18 are located closer to the first manifold pore 15 than the islands 19 formed as column-shaped projections.

### <Second Separators 20>

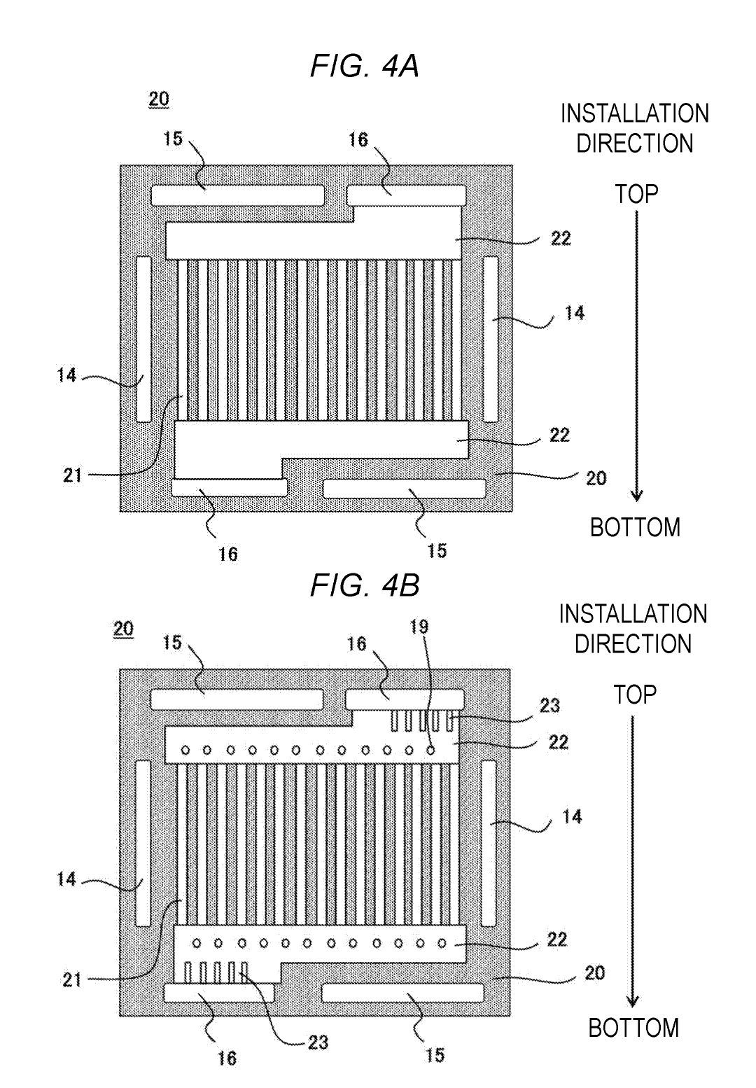

FIG. 4A is a plan view of the second separators 20 on the anode side.

As shown in FIG. 4A, the second separators 20 may be provided with a second manifold pore 16, and a second gas-introducing part 22 that communicates with anode gas flow channels 21.

As shown in FIG. 4B, the second gas-introducing part 22 may be provided with multiple projections 23 that communicate with one end of the second manifold pore 16 and islands 19.

Sealing members (not shown in figures) can be provided on surface sides of the refrigerant flow channels 7 of the first separators 4 and 20, as needed.

### <Frame 6>

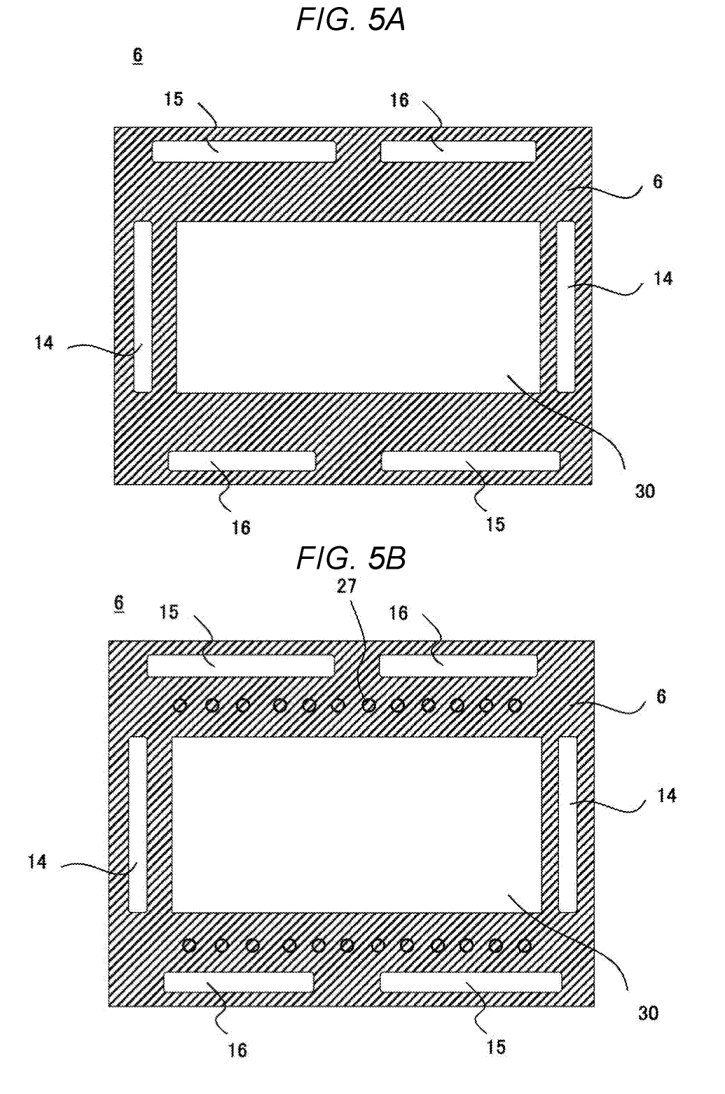

FIG. 5A is a plan view of the frame 6.

As shown in FIG. 5A, the frame 6 has refrigerant manifold pores 14, first manifold pores 15, and second manifold pores 16.

The frame 6 is brought into contact with the first separator 4, the second separator 20, and the membrane-electrode assembly 10, thus conducting currents. Therefore, a through hole 30 having an area equivalent to that of the membrane-electrode assembly 10 is provided with a center of the frame 6.

The refrigerant manifold pore 14, the first manifold pore 15, and the second manifold pore 16 provided in the frame 6 communicate with manifold pores provided in the cathode-side first separator 4 and the anode-side second separator 20, respectively, that come closer to one another when theses members are fastened.

As shown in FIG. 5B, the frame 6 may be provided with column-shaped islands 27 (projections).

### <Others>

One example of layering procedures for the cell 1 will described below with reference to FIG. 2A.

As shown in FIG. 2A, an adhesive layer 3a is provided between opposed surfaces of the first separator 4 and the frame 6.

An adhesive layer 3b is provided between opposed surfaces of the second separator 20 and the frame 6.

The adhesive layers 3a and 3b serve as seal members that prevent mixture or leakage of the gases.

The thickness of the adhesive layer 3a may be equal to or smaller than the thickness of the cathode-gas-diffusion layer 8.

The thickness of the adhesive layer 3b may be equal to or smaller than the thickness of the anode-gas-diffusion layer 9.

Moreover, as shown in FIG. 2B, a frame 24a with a column-shaped island 27a may be provided on a surface that is brought into contact with the first separators 4.

Furthermore, a frame 24c with a column-shaped island 27b may be provided on a surface that is brought into contact with the second separator 20.

The frame 24a and the frame 24b are formed into a single body based on an adhesive layer 3c to form the layer structure of the cell 1.

In that case, the thickness of the adhesive layer 3c may be equal to the thickness of the electrolyte membrane 12.

As examples of resin materials used for forming the adhesive layers 3a, 3b, 3c, thermoplastic materials (e.g., modified polypropylenes) and thermosetting materials (e.g., epoxy resins) can be mentioned.

### <Operation>

Operation of the cell 1 configured in the above manner will be described below.

As shown in FIG. 3A, while oxidant gas such as an oxygen-containing gas is supplied into the first manifold pore 15, a fuel gas such as a hydrogen-containing gas is supplied into a second manifold pore 16.

Furthermore, a refrigerant such as pure water or ethylene glycol is supplied into the refrigerant manifold pore 14.

As shown in FIG. 3A, the oxidant gas is introduced into a first gas-introducing part 17 through the first manifold pore 15, and then, is supplied into the cathode gas flow channels 5.

The oxidant gas flows to the direction toward the cathode-gas-diffusion layer 8 (FIG. 2A) along the cathode gas flow channels 5.

As shown in FIG. 4A, the fuel gas is introduced into the second gas-introducing part 22 through the second manifold pore 16, and then, is supplied into the anode gas flow channels 21.

The fuel gas flows to the direction toward the anode-gas-diffusion layer 9 (FIG. 2B) along the anode gas flow channels 21.

Either the upper or lower manifolds may serve as an introduction or discharge side.

In the above-described polymer electrolyte cell 1, reactions described below occur.

When hydrogen in the fuel gas is supplied to the anode catalyst layer 13 through the anode-gas-diffusion layer 9, a reaction shown by Formula (I) is caused in the anode catalyst layer 13, and thus, hydrogen is decomposed into protons and electrons.

The protons travel through the electrolyte membrane 12 toward the cathode catalyst layer 11.

The electrons travel to an external circuit (not shown in figures) through the anode-gas-diffusion layer 9 and the second separators 20, and then, flow into the cathode catalyst layer 11 through the first separators 4 and the cathode-gas-diffusion layer 8 from the external circuit.

When the air in the oxidant gas is supplied into the cathode catalyst layer 11 through the cathode-gas-diffusion layer 8, a reaction shown by Formula (II) is caused in the cathode catalyst layer 11, and thus, oxygen in the air is reacted with the protons and the electrons to produce water.

As a result, the electrons are caused to flow in the external circuit toward the direction from the anode to the cathode, and thus, the power can be retrieved.

Anode catalyst layer 13: H₂→2H⁺+2e⁻ Formula (I)

Cathode catalyst layer 11: 2H⁺+(½)O₂+2e⁻→H₂O Formula (II)

The oxidant gas consumed in the membrane-electrode assembly 10 is discharged from the first gas-introducing part 17 toward the first manifold pore 15 (FIG. 3A).

Furthermore, the fuel gas consumed in the membrane-electrode assembly 10 is discharged from the second gas-introducing part 22 toward the second manifold pore 16 (FIG. 4A).

The refrigerant supplied into either of the refrigerant manifold pores 14, which serves as an inlet, is supplied to the refrigerant flow channels 7. The refrigerant cools the membrane-electrode assembly 10, and then, is discharged from the other refrigerant manifold pore 14 that serves as an outlet.

### Second Embodiment

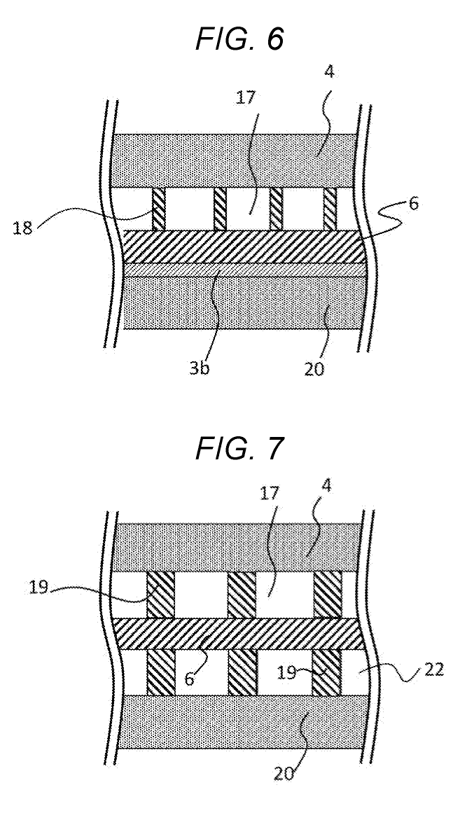

FIG. 6 is a cross-section view (partially expanded view) of the cell 1 along the line B-B in FIG. 3B.

The projections 18 that are connected to the first manifold pore 15 are brought into contact with the frame 6, and the frame 6 is integrated with the anode-side second separator 20 through the anode-side adhesive layer 3b, thereby retaining gas-seal properties.

As shown in FIG. 6, the frame 6 is pressed by the projections 18 connected to the first manifold pore 15, when fastened at a certain load, and therefore, it is required that the frame 6 has a thickness sufficient to keep from deforming when fastened at the certain load.

FIG. 7 is a cross-section view (partially expanded view) of the cell 1 along the line C-C in FIG. 3B.

The frame 6 is placed between the islands 19 in the first gas-introducing part 17 and the islands 19 in the second gas-introducing part 22, and therefore, it is required that the frame 6 has a thickness sufficient to keep from deforming when fastened at the certain load.

Furthermore, when a difference between pressures in the first gas-introducing part 17 and the second gas-introducing part 22 is, for example, about 50 KPa or higher, there is a risk in which, due to the pressure from the second gas-introducing part 22, the frame 6 deforms toward the first gas-introducing part 17, and, consequently penetrates into spaces between the islands 19, thus impeding the supply of oxidant gas or fuel gas into the flow channels.

For example, when the heights of the first gas-introducing part 17 and the second gas-introducing part 22 are adjusted to about 1 mm or smaller for the purpose of reducing the thickness of the cell 1, an allowable amount of strain of the frame 6 due to the deformation caused by fastening at a certain load may need to be about 1 mm or smaller such that the frame 6 is not brought into contact with the first gas-introducing part 17 or the second gas-introducing part 22.

An amount of deflection of the frame 6 is proportional to an interval between the islands 19 (distance between the islands) and is inversely proportional to the Young's modulus and the thickness of the frame 6.

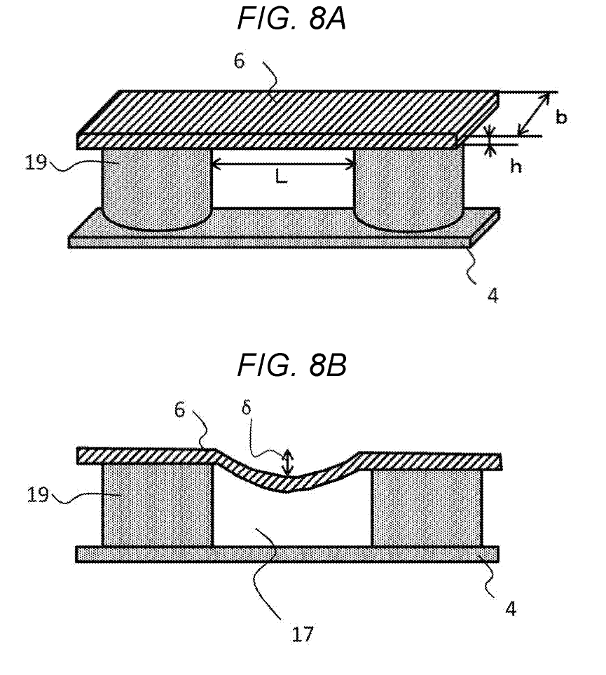

FIG. 8A is a cross-section view (partially expanded view) of the cell 1 along the line C-C in FIG. 3B, and simplistically illustrates parts of the islands 19 that are in contact with the frame 6.

FIG. 8B shows a state (cross-section) in which the frame 6 is not able to stand against the load and is thus deformed.

In order to prevent such deformation of the frame 6, there would be a countermeasure in which a distance L between the islands 19 is made shorter. However, if a number of islands 19 are consequently provided, a main function of the gas-introducing part (i.e., effects to uniformly introduce the gas into the channels) may be affected.

Furthermore, if a number of islands 19 are provided in the first gas-introducing part 17 and the second gas-introducing part 22 in order to prevent deformation of the frame 6, volumes of spaces occupied by the islands 19 become excessively larger against volumes of spaces in the first and second gas-introducing parts. Thus, loss of pressure in therein may be increased. Consequently, efficiencies of the fuel cell may be affected.

On the other hand, if the distance between the islands 19 is made shorter while the thickness of the frame 6 is increased without providing a number of islands 19 in the first gas-introducing part 17, the following problem may be raised. That is, since it is required that the thickness of the frame 6 and the thickness of the membrane-electrode assembly 10 are approximately the same, the thickness of the membrane-electrode assembly 10 may be increased, and thus, the performance of the cell 1 may be deteriorated.

Therefore, it would be possible to adopt a material with a larger value of the Young's modulus for the frame 6 to improve the rigidness, so as to prevent occurrence of the deformation due to the fastening load, while simultaneously realizing reductions in the thickness of the cell.

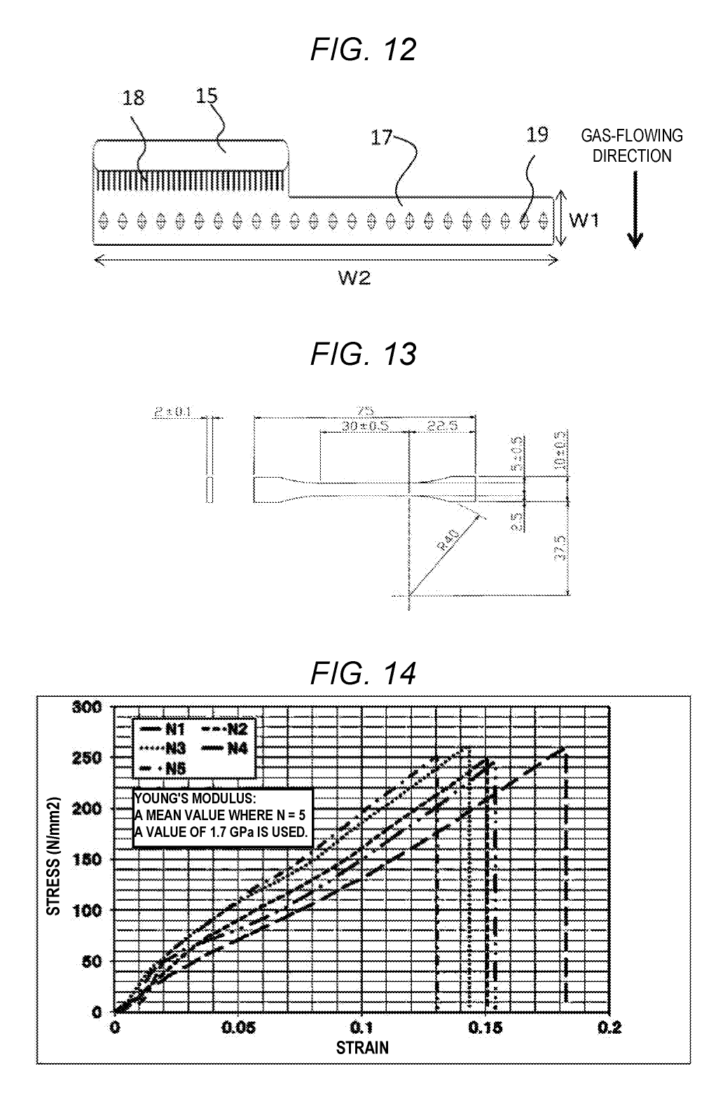

In consideration of the degree of the Young's modulus, the vertical-direction width W2 (FIG. 12) may be adjusted to, e.g., about 212 mm, against the gas-flowing direction in the first gas-introducing part 17 and the second gas-introducing part 22.

In that case, the sum of distances L (FIG. 8A) intervals between islands 19 may be adjusted to be equal to or larger than about ⅔ of the vertical-direction width W2, in order to secure a sufficient flow-adjusting function of the first gas-introducing part 17.

Cases in which the islands 19 are provided such that the distance L between the islands 19 becomes about 8.5 mm or smaller were studied.

With regard to a case where the thickness h of the frame 6 (FIG. 8A) is adjusted about 0.2 mm in that case, required values of the Young's modulus for the frame 6 were calculated. The results are shown in Table 1.

Deflection amounts δ (FIG. 8B) of the frame 6 in Table 1 were calculated based on the formula regarding a beam simply supported at the ends.

TABLE 1

| | Comparative | Comparative | Example |
|---|---|---|---|
| | Example 1 | Example 2 | 1 |
| Thickness h of frame 6 [mm] | 0.200 | | |
| Pressure in space in first | 0.070 | | |
| gas-introducing part 17 [MPa] | | | |
| Distance L between islands | 7.50 | | |
| 19 [mm] | | | |
| Young's modulus E of | 0.5 | 0.75 | 1.0 |
| frame 6 [GPa] | | | |
| Deflection amount δ of | 1.73 | 1.15 | 0.87 |
| frame 6 [mm] | | | |

In a case where the height of the first gas-introducing part 17 is about 1 mm, an allowable value of the deflection amount 6 of the frame 6 due to a pressure in the spaces in the second gas-introducing part 22, which is applied through the membrane-electrode assembly 10, may be about 1 mm or smaller.

If the above condition is not fulfilled, the deformed frame 6 may be brought into contact with the bottom of the first gas-introduction part 7, and thus, may impede the gas flow.

In view of the results shown in Table 1, when the Young's modulus of the frame 6 is about 1 GPa or higher, the deflection amount 6 of the frame 6 is equal to or smaller than about 1 mm, which is equivalent to the height of the first gas-introduction part 7, and thus, is within an allowable range.

It is required that the Young's modulus of the frame 6 is at least about 1 GPa or higher.

Furthermore, even if the Young's modulus is equal to about 1 GPa, it would be difficult to form the frame 6 so as to have a thickness approximately equal to the thickness of the membrane-electrode assembly 10 when, e.g., polypropylene, which is a widely used plastic material, is used to form the frame 6 around the outer periphery of the membrane-electrode assembly 10 based on injection molding, because of flowability of the plastic material.

On the other hand, when reinforced plastic molding materials obtained by uniformly impregnating thermosetting resins such as epoxy resins into fibrous reinforcing materials, followed by a treatment of partial curing, are used for the frame 6, it would become possible to define the thickness of the frame 6 based on the thickness of the reinforced plastic molding materials. Also, the frame 6 would stand against the allowable stress even if the frame 6 have a thickness equal to the thickness of the membrane-electrode assembly 10.

Thus, when the frame 6 is formed based on such materials obtained by impregnating resins into fibrous reinforcing materials, it would become possible to prevent expected deformation of the frame 6 caused due to fastening loads, and to simultaneously reduce the thickness of the cell.

Additionally, the same components as those found in the cell according to the first embodiment are referenced by the same symbols, and detailed descriptions thereon are omitted.

### Third Embodiment

Next, the third embodiment will be described.

Additionally, the same components as those found in the cells 1 of the first and second embodiments will be referenced by the same symbols, and detailed descriptions thereon will be omitted.

Matters not mentioned in this embodiment are the same those described in the first and second embodiments.

In cases where islands 27a and 27b, which are formed as projections, are provided in the frames 24a and 24b, respectively, as shown in FIG. 2B, the first gas-introducing part 17 and the second gas-introducing part 22 in the first separator 4 and the second separator 20, respectively, can be formed without any precision machining processes.

When the cell 1 is subjected to battery evaluations based on countercurrents, for example, the pressure in the first gas-introducing part 17 is higher than the pressure in the second gas-introducing part 22 on the first gas-supply manifold side.

On the other hand, the pressure in the second gas-introducing part 22 is higher than the pressure in the first gas-introducing part 17 on the first gas-discharge manifold side.

As compared with metal/carbon separators, by providing islands formed as projections, on the side of the frame, which has a higher degree of freedom in workability, it becomes easier to control the fastening pressure.

Also, in the frame 6, since configurations of the first separator 4 and the second separator 20 are simple, the number of steps for machining processes for the separators will be reduced.

Furthermore, by way of causing pitches of the islands 27a and 27b on the both sides to coincide with each other, effects to suppress the deformation caused due to the fastening load will be obtained.

The positions of the islands 27a and 27b on the both sides may preferably coincide with each other in the vertical direction, i.e., in the direction in which the frame 24a and the frame 24b are stacked.

### Fourth Embodiment

Next, the fourth embodiment will be described.

The same components as those found in the cells according to the first to third embodiments will be referenced by the same symbols, and detailed descriptions thereon will be omitted.

Matters not mentioned in this embodiment are the same as those described in the first to third embodiments.

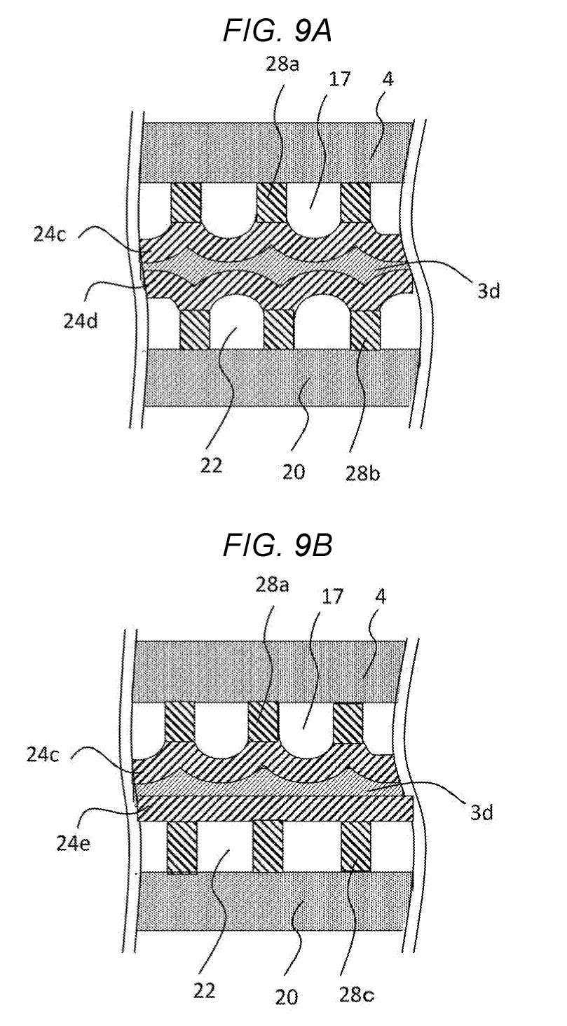

FIG. 9A is a cross-section view of the cell 1 according to the fourth embodiment and is a cross-section view (partially enlarged view) of an area corresponding to the cross-section along the line A-A in FIG. 2B.

As shown in FIG. 9A, islands 28a provided on the frame 24c are in contact with the first separator 4 inside a space in the first gas-introducing part 17.

Inside a space in the second gas-introducing part 22, islands 28b provided on the frame 24d are in contact with the second separators 20.

The frame 24c and the frame 24d are integrated with each other based on the adhesive layer 3d.

Contact surfaces of the frame 24c and the frame 24d against the adhesive layer 3d may be formed in curved shapes, and thus, local loads can be dispersed when the layering and fastening process is carried out to form the cell 1.

When parts of the frame 24c in intervals between the islands 28a, and parts of the frame 24d in intervals between the islands 28b are formed in curved shapes, local loads can be dispersed during the layering process for forming the cell 1, and, simultaneously, larger space volumes of the first gas-introducing part 17 and the second gas-introducing part 22 can be secured.

Accordingly, gases flowing into the first gas-introducing part 17 and the second gas-introducing part 22 can be caused to flow without in unbiased manner, and thus, loss of pressure can be reduced.

As a result, suppression of the deformation due to higher pressures, and reductions in the thickness of the cell can simultaneously be realized.

Additionally, as shown in FIG. 9B, only the frame 24c that is brought into contact with the side of first separator 4 where the gas flow is particularly larger, and the air, which has higher viscosity, is supplied, or only contact surfaces of the frame 24c against the adhesive layer 3c, and parts of frame 24c in intervals between the islands 28a may be formed in curved shapes.

In that case, regions of the frame 24e extending between the islands 28b that are in contact with the second separator 20 in the second gas-introducing part 22, and that are provided on the frame 24e, may be shaped in rectangular shapes.

### Fifth Embodiment

Next, the fifth embodiment will be described.

The same components as those found in the cells 1 of the first to fourth embodiments will be referenced by the same symbols, and detailed descriptions thereon will be omitted.

Matters not mentioned in this embodiment are the same as those described in the first and second embodiments.

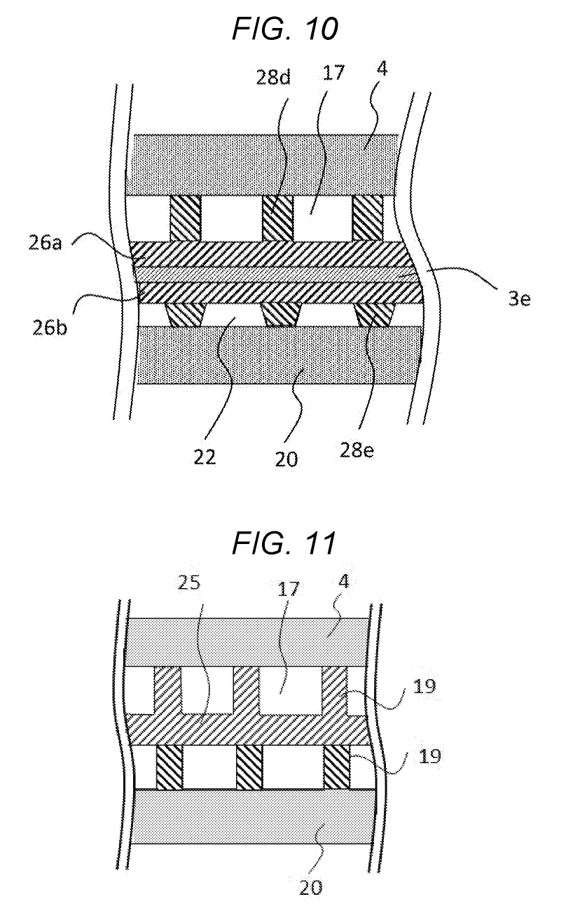

FIG. 10 is a cross-section view of a cell 1 according to the fifth embodiment and is a cross-section view (partially enlarged view) of an area corresponding to the cross-section along the line A-A in FIG. 2B.

As shown in FIG. 10, the islands 28d, i.e., column-shaped projections, provided on the frame 26a are brought into contact with the first separator 4 inside a space in the first gas-introducing part 17.

Inside a space in the second gas-introducing part 22, the islands 28e, i.e., column-shaped projections, provided on the frame 26b are brought into contact with the second separator 20.

The frame 26a and the frame 16c are integrated with each other based on the adhesive layer 3e.

Dimensions of the islands 28d and 28e (i.e., heights and widths of projections) differs from each other.

It is required that the islands 28d that are brought into contact with first separator 4 where the gas flow is particularly larger, and the air, which has higher viscosity, is supplied, have a height larger than the islands 28e, in order to reduce loss of pressures in the first gas-introducing part 17. Meanwhile, it is required that the islands 28e that are brought into contact with the second separator 20 are resistant to the deformation caused due to the pressure from the first gas-introducing part 17.

Therefore, heights of projections of the islands 28e may be made smaller, and the projections may be formed in about trapezoidal shapes, such that it becomes possible to realize a thinner cell structure that is resistant to the deformation possibly caused when applied with pressures.

However, since the degrees of loss of pressure at the gas-supply side and the gas-discharge side vary, the islands 28d are placed close to the cathode side in the first gas-introducing part 17, which is close to the first-gas-supply-side manifold, and the islands 28e are placed close to the anode side, i.e., the first gas-discharge-side manifold.

The islands 28d may be placed on the cathode side, and the islands 28e may be placed at the anode side, so as to further suppress the deformation of the frames.

### Sixth Embodiment

Next, the sixth embodiment will be described.

FIG. 11 is a cross-section view of a cell 1 according to the sixth embodiment and is a cross-section view of an area corresponding to the cross-section along the line C-C in FIG. 3B.

Additionally, the same components as those found in the cells 1 of the first embodiment will be referenced by the same symbols, and detailed descriptions thereon will be omitted.

Matters not mentioned in this embodiment are the same as those described in the first to fifth embodiments.

As shown in FIG. 11, the frame 25 has a structure in which it is formed as a single body in combination with the islands 19 at one side.

That is, the frame 25 and the islands 19 that have been separately produced are not connected to each other. These members are formed as a single body of a frame 25 with islands 19.

By integrally providing the islands 19 on the frame 25 in the above manner, any precise machining processes are not required to form the first gas-introducing part 17 in the cathode-side first separator 4.

Thus, the configuration becomes simpler, and the number of steps for machining processes for the first separator 4 will be reduced.

Since the structure according to the sixth embodiment is an integrated structure in which the shape of the frame 25 simultaneously functions as the frame 6 and the islands 19, it becomes possible to suppress the deformation when fastened at a certain load, and also becomes possible to reduce the thickness of the cell 1, in the same manner.

As shown in FIG. 12, projections 18 provided so as to connect to the first manifold pore 15, or projections 23 provided so as to connect to the second manifold pore 16 may be formed as a single body in combination with the frame 25.

### EXAMPLES

Examples will be shown below.

FIG. 12 is a plan view that only shows the first gas-introducing part 17 provided in the first separator 4 on the cathode side.

A vertical direction width W2 that is an introduction part width perpendicular to the flowing direction of the gas flown from the first manifold pore was adjusted to 212 mm, and the gas-flowing direction width W1 was adjusted to 11 mm to define the shape of the first gas-introducing part 17 in the planar direction, and thus, a first separator 4 was prepared.

The frame 6, and the projections 18 and the islands 19 were brought into contact with each other when the cell 1 was fastened. A cathode gas (the air) was caused to flow through the resulting spaces (first gas-introducing part 17).

Values for loss of pressure of the viscous air passing through the first gas-introducing part 17 provided by bringing the frame 6, the projection 18 and the islands 19 into contact with one another were obtained based on three dimensional calculations using a widely used analysis software (FLUENT).

Changes in the pressure loss in cases where the frame 6 was deformed as shown in FIG. 8B, and thus blocked the first gas-introducing part 17 are shown in Table 2.

The flow rate of the air was adjusted to 13.9 L/min. Values for physical properties of viscosity and the density of the air were estimated based on values at 80° C., which fell within a temperature range for operation of the cell, with reference to “heat-transfer engineering handbook” (MARUZEN PUBLISHING CO., LTD.).

In table 2, cases in which any deformation of the frame 6 were not caused due to the loads applied thereto were considered “no deformation.”

Calculations were carried out with respect to the following three cases: (i) a case in which the frame 6 was not deformed, (ii) a case in which the frame 6 was deformed due to the load, such that the frame 6 blocked the space in the first gas-introducing part 17 formed by the frame 6 and the first separator 4 at the cathode side, by 0.05 mm and (iii) a case in which the frame 6 was deformed due to the load, such that the frame 6 blocked the space in the first gas-introducing part 17, by 0.1 mm.

Table 2 shows results of the introduction part due to the deformation of the frame, and the loss of pressure.

TABLE 2

| | | | Comparative |
|---|---|---|---|
| | Example 2 | Example 3 | Example 3 |
| Frame 6 | No deformation | 0.05 mm | 0.1 mm |
| | | blockage | blockage |
| Pressure loss in cathode | 4.0 | 4.9 | 6.25 |
| introduction part [KPa] | | | |
| Acceptance | Yes | Yes | No |

In view of the results shown in Table 2, when an amount of change in the pressure loss in the first gas-introducing part 17 is 1.0 KPa or lower (in this case, up to 5.0 KPa), it is required that an amount of blockage in the space in the first gas-introducing part 17 due to the deformation of the frame 6 is 0.05 mm or smaller.

A reason why a value of 1 K Pa or less was selected for the amount of change in the pressure loss in the first gas-introducing part 17 is that such a value was considered reasonable in consideration of the amplitude of voltages in battery evaluation tests.

Based on the calculation results shown in Table 2, calculations on the strength of the frame 6 were carried out to evaluate whether there are any intervals of the islands 19 (distance between the adjacent islands) that do not cause blockage of the gas flow in the first gas-introducing part 17, showing that the degree of blockage due to the deformation of the frame 6 is 0.05 mm or smaller.

The above calculations on the strength were based on the formula regarding abeam simply supported at the ends because it was considered that deflection amounts δ of the frame 6 can be simulated based on this formula.

In order to estimate blockage amounts in the cross-section direction based on the deflection amounts δ of the frame 6, the deflection amounts δ were divided by areas of semicircles of distances L between the islands so as to convert the deflection amounts δ to blockage amounts.

In order to calculate values of the Young's modulus for the frame 6, the JIS K7161 plastic tensile property test was carried out, and, as a result, the Young's modulus of the frame 6 was 1.7 GPa.

FIG. 13 is a view that shows a shape of a measurement specimen subjected to the JIS K7161 plastic tensile property test.

FIG. 14 shows results of the JIS K7161 plastic tensile property test with respect to the frame 6 where the shape of the test specimen shown in FIG. 13 was used.

FIG. 14 shows stress-strain curves obtained from test loads-stroke length with respect to the dumbbell shape in FIG. 13 by using a tensile property test machine (“EZGraph” manufactured by SHIMADZU CORPORATION).

The measurements were carried out where N=5, and mean values of the Young's modulus were calculated.

Table 3 shows results of estimation of the distance L between the islands, and the amounts of blockage in the first gas-introducing part 17 when the width b and the thickness h of the frame 6 supported by the islands 19 as shown in FIGS. 8A and 8B were set to realistic values.

TABLE 3

| | Comparative | Comparative | Example |
|---|---|---|---|
| | Example 4 | Example 5 | 4 |
| Width b of frame 6 [mm] | 2.000 | | |
| Thickness h of frame 6 [mm] | 0.200 | | |
| Pressure within second | 0.070 | | |
| gas-introducing part 22 [MPa] | | | |
| Young's modulus E of frame | 1.700 | | |
| 6 [GPa] | | | |
| Distance L between islands | 5.20 | 5.00 | 4.50 |
| 19 [mm] | | | |
| Deflection amount δ of | 0.12 | 0.10 | 0.07 |
| frame 6 [mm] | | | |
| Amount of blockage of first gas | 0.09 | 0.08 | 0.05 |
| introduction part 17 based on | | | |
| rectangular conversion [mm] | | | |
| Acceptance | No | No | Yes |

As shown in Table 3, when the distance L between the islands 19 is 4.5 mm or smaller, deformation of the frame 6 can be prevented even when the high-pressure air is caused to flow into the second gas-introducing part 22, which is a space formed by the frame 6 and the second separator 20 at the anode side.

Furthermore, by preventing deformation of the frame 6, it becomes possible to prevent occurrence of uneven flow of gases into the first gas-introducing part 17, and thus, a function of gas equidistribution of the first gas-introducing part 17 can be secured.

Based on the results shown in Tables 2 and 3, it is possible to suppress the deformation of the frame 6 to a certain value or lower, thereby realizing a favorable shape of cell without affecting the space in the first gas-introducing part 17 frame 6, when the Young's modulus is 1 GPa or higher.

### (On the Whole)

Matters described for the first gas-introducing part 17 shall apply to the second gas-introducing part 22.

Furthermore, matters described for the second gas-introducing part 22 shall also apply to the first gas-introducing part 17.

In addition, it would be sufficient that the above-described features are applied to at least one of the first gas-introducing part 17 and the second gas-introducing part 22.

The fuel cells of the disclosure can be employed as fuel cells for various purposes including household use, and vehicle use.

What is claimed is:

1. A fuel cell, comprising:
a polymer electrolyte membrane;
a pair of catalyst layers;
a pair of gas-diffusion layers;
a pair of separators including first and second separators; and
at least one frame, wherein
the catalyst layers, the gas-diffusion layers, and the separators are placed respectively on both sides of the polymer electrolyte membrane in this order,
the at least one frame is placed between the pair of the separators, and surrounds outer peripheries of the gas-diffusion layers and the catalyst layers, and
the frame has a rigidity of about 1 GPa or higher in terms of a Young's modulus.

2. The fuel cell according to claim 1, wherein the at least one frame is formed of a material obtained by impregnating a thermosetting resin into a fibrous reinforcing material.

3. The fuel cell according to claim 1, wherein a cathode-gas flow channel is formed on the first separator, an anode-gas flow channel is formed on the second separator, a first manifold pore for gas supply or discharge is provided in the first separator, a second manifold pore for gas supply or discharge is provided in the second separator, a first gas-introducing part that connects the cathode-gas flow channel and the first manifold pore, and a second gas-introducing part that connects the anode-gas flow channel and the second manifold pore are provided, and multiple linear projections, and multiple column-shaped islands are provided on the at least one frame within at least one of the first gas-introducing part and the second gas-introducing part.

4. The fuel cell according to claim 3, wherein the islands are provided within both of the first gas-introducing part and the second gas-introducing part.

5. The fuel cell according to claim 4, wherein the at least one frame has curved shapes in areas between the islands.

6. The fuel cell according to claim 4, wherein shapes of the islands provided in the first gas-introducing part differs from shapes of the islands provided in the second gas-introducing part.

7. The fuel cell according to claim 4, wherein positions of the islands provided in the first gas-introducing part coincide with positions of the islands provided in the second gas-introducing part in a stack direction of the first gas-introducing part and the second gas-introducing part.

8. The fuel cell according to claim 3, wherein the at least one frame and the islands are formed as a single body.

9. The fuel cell according to claim 3, wherein the at least one frame includes a first frame and a second frame, the first frame is provided in the first gas-introducing part, the second frame is provided in the second gas-introducing part, and the first frame and the second frame are retained based on an adhesive layer.

10. The fuel cell according to claim 3, wherein the linear projections are located closer to the first manifold pore than the islands.
